(19) United States
(12) Patent Application Publication
(10) Pub. No.: US 2012/0274680 A1
(43) Pub. Date: Nov. 1, 2012

(54) STYLUS WITH CARBON FIBER

(75) Inventor: JAMES A. HOFMAN, Shorewood, MN (US)

(73) Assignee: Silk Road Gifts, Inc., Secaucus, NJ (US)

(21) Appl. No.: 13/097,058

(22) Filed: Apr. 29, 2011

(51) Int. Cl. G01D 15/02

(52) U.S. Cl. 346/139 C

(57) ABSTRACT

A stylus includes an elongated body a portion of which is formed from carbon fiber and a tip conductively coupled to the elongated body.

### BACKGROUND

The present application relates generally to the field devices for interfacing with touch screens. More particularly the application relates to a stylus for use with a capacitive touch screen.

With the increased use of devices such as mobile phones, MP3 players, tablet computers and other similar devices, capacitive touch screens have become more widespread. Capacitive touch screens sense a capacitance change when a conductive object such as a portion of a human body contacts the screen. By localizing the change in capacitance, the position of the object can be determined.

A user generally interfaces with a capacitive touch screen with a finger tip. However, the use of a finger can leave fingerprints and smudges on the screen and can sometimes be imprecise when interacting with small items on a crowded screen. A conductive pointing device such as a stylus may be used to allow the user to interact with the screen with increased precision. It would desirable, therefore, to provide an improves stylus that can be used with a capacitive touch screen.

### SUMMARY

One embodiment of the invention relates to a stylus an elongated body a portion of which is formed from carbon fiber and a tip conductively coupled to the elongated body. The body may include a front barrel and a rear barrel with a conductive ring therebetween. The front barrel may be formed from a carbon fiber weave with a weft and warp portion extending the entire length of the front barrel. Similarly, the rear barrel may be formed from a carbon fiber weave with a weft and warp portion extending the entire length of the rear barrel. The tip may be flexible and formed from a conductive plastic compound material.

Another embodiment relates to a conductive stylus for use with a capacitive sensing screen. The stylus includes an elongated body including a portion formed from a conductive carbon fiber weave. A conductive tip is conductively coupled to the elongated body. The portion formed from a conductive carbon fiber weave extends from a first end of the elongated proximate the tip in a direction towards a second end distal from the tip.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of a stylus according to an exemplary embodiment.

FIG. 2 is an exploded view of the stylus in FIG. 1.

FIG. 3 is a cross-section view of the stylus in FIG. 1 taken along line 3-3.

FIG. 4 is a detail cross-section view of the stylus in FIG. 1 showing the tip being deformed by contact with a surface.

FIG. 5 is a perspective view of a case and stand for the stylus in FIG. 1 according to an exemplary embodiment.

FIG. 6 is a side view of a stylus with a portion manufactured from fiber carbon.

FIG. 7 is a side view of the stylus in FIG. 7 with an additional portion manufactured from fiber carbon.

### DETAILED DESCRIPTION

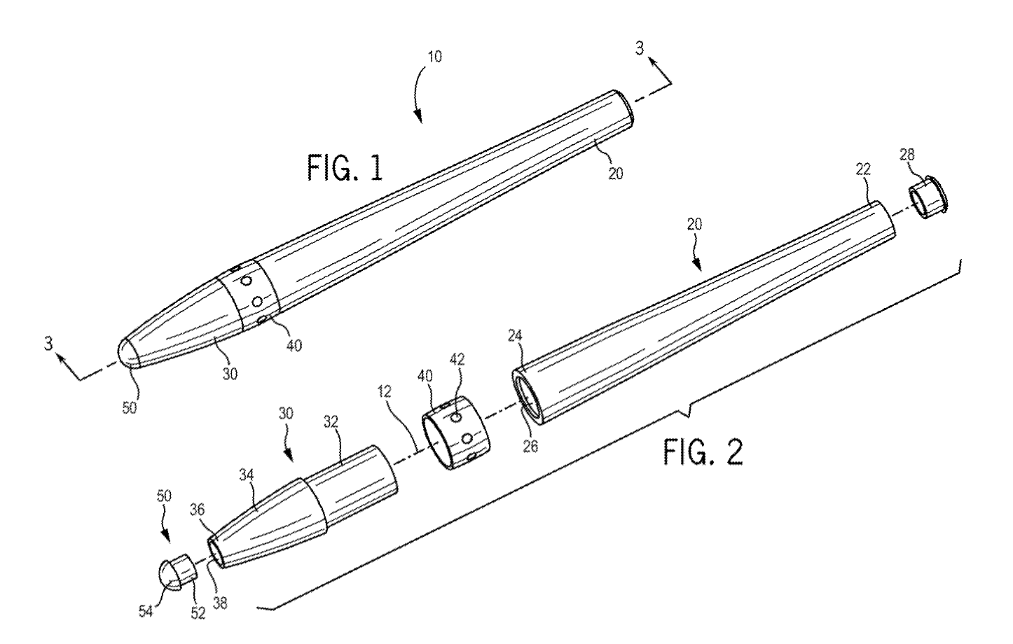

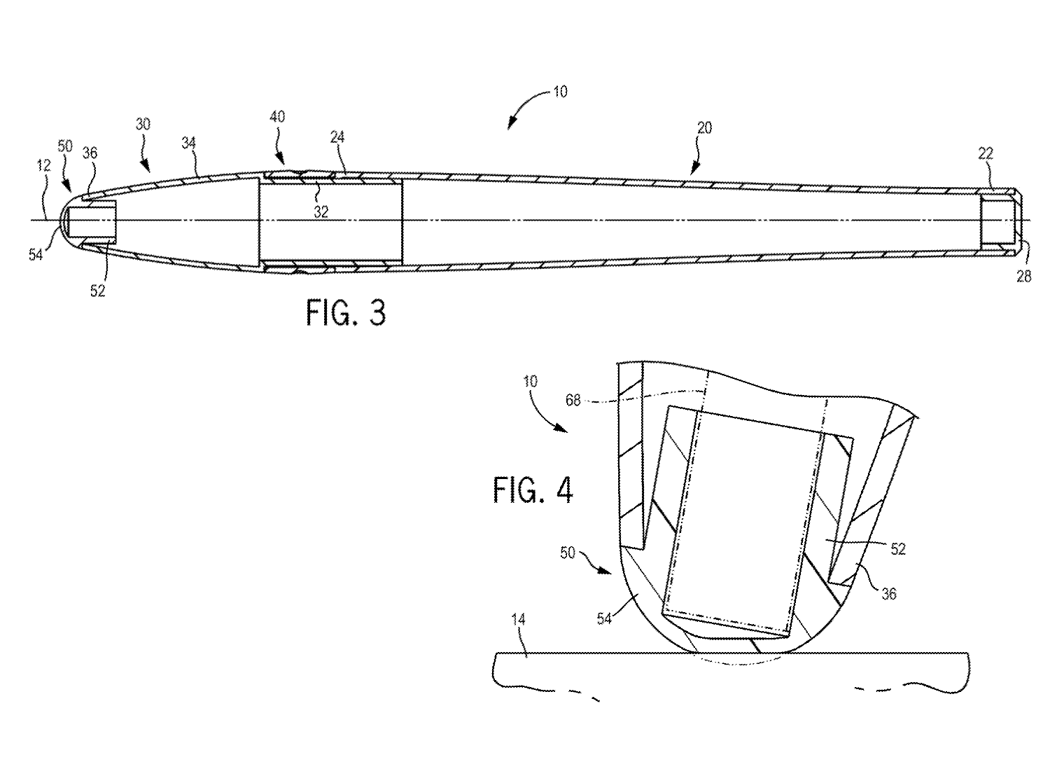

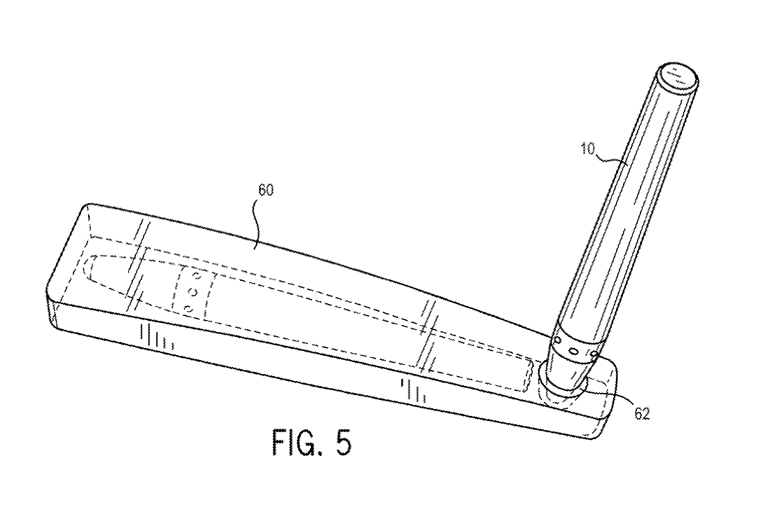

Referring in general to FIGS. 1-5, a stylus 10 is shown according to an exemplary embodiment. The stylus 10 may be used, for example to interface with an electronic device having a touch screen 14 (see FIG. 4), such as a mobile phone, a tablet computer, a PDA, a GPS unit, an MPS player, or another similar device.

As will be discussed in greater detail, stylus 10 includes features for improved use with a capacitive touch screen. However, stylus 10 may also be used with any suitable touch screen technology, such as resistive touch screens, or touch screens using surface acoustic wave technology.

Stylus 10 is an elongated body with a longitudinal axis 12. In one embodiment stylus 10 includes a rear barrel 20, a front barrel 30, a trim ring 40, and a tip 50. Stylus 10 has an ergonomic wide-body shape that is configured to be comfortably held by a user similar to a pen or other writing instrument. When oriented generally perpendicular to a touch screen 14, applying a force along the longitudinal axis 12 presses stylus 10 against the touch screen 14 and applying a force lateral to longitudinal axis 12 draws stylus across the touch screen 14.

Rear barrel 20 (e.g., first barrel, shaft, etc.) provides the main body of stylus 10. Rear barrel 20 may be a hollow, tubular body with a first end 22 and a second end 24. According to an exemplary embodiment, rear barrel 20 is tapered such that the first end 22 has a smaller diameter than the second end 24. In one embodiment, the first end 22 is open and a cap 28 is received in the interior 26 of rear barrel 20 to close the first end 22. In other embodiments, the first end may be closed with an integrally formed cap (e.g., squared off, rounded, tapered to a point, etc). Cap 28 may include a pen clip (not shown) that extends from the tip about rear barrel 20 permitting stylus 10 to be clipped to a users shirt pocket or to a device holder.

The second end 24 of rear barrel 20 is coupled to front barrel 30 (e.g., second barrel, insert, etc.). Front barrel 30 is a hollow member with a first portion 32 and a second portion 34. First portion 32 is a generally cylindrical body with a diameter that is substantially equal to the diameter of the interior 26 of rear barrel 20. First portion 32 of front barrel 30 is received by the second end 24 of rear barrel 20 to couple front barrel 30 to rear barrel 20 with an interference fit. Second end 24 may include features such as a raised interior ridge to facilitate the coupling of rear barrel 20 to front barrel 30. Other means such as an adhesive may be used to further couple rear barrel 20 to front barrel 30.

Trim ring 40 is provided between rear barrel 20 and front barrel 30. Trim ring 40 is a hollow cylindrical member with an inner diameter that is greater than the diameter of first portion 32 of front barrel 30 to allow first portion 32 to pass freely through trim ring 40. The outer diameter of trim ring 40 is approximately equal to the outer diameter of the second end 24 of rear barrel 20. Trim ring 40 may include one or more indentations 42 (e.g., depressions, dimples, etc.) or other decorative features.

Second portion 34 of front barrel 30 is a tapered body with a hollow distal end 36 that receives tip 50. The diameter of second portion 34 proximate to first portion 32 is approximately equal to the outer diameter of trim ring 40 to create a smooth contour along the outer surface of stylus 10 between rear barrel 20, trim ring 40, and front barrel 30.

Tip 50 includes a coupling portion 52 and a contact portion 54 Coupling portion 52 is a generally cylindrical body with a diameter that is substantially equal to the diameter of the interior 38 of front barrel 30 (e.g., second portion 34 at hollow end 36). Coupling portion 52 of tip 50 is received by hollow end 36 of front barrel 30 to couple tip 50 to front barrel 30 with an interference fit. Hollow end 36 may include features such as a raised interior ridge to facilitate the coupling of tip 50 to front barrel 30. Other means such as an adhesive may be used to further couple tip 50 to front barrel 30.

Contact portion 54 (e.g., flexible portion, contact portion, etc.) is a generally hemispherical body that is configured to contact touch screen 14. Contact portion 54 may be formed of a resilient material and has a contact surface area or footprint that is proportional to the force applied to stylus 10 along longitudinal axis 12. With minimal force being applied to stylus 10 along longitudinal axis 12, contact portion 54 has a relatively small footprint. Referring to FIG. 4, increased force applied to stylus 10 deforms contact portion 54 and increases the size of the contact area between the tip and a screen 14. In this manner the footprint of the tip may be modified. The change in footprint may be interpreted by software to more closely reproduce writing with non-electronic media. For example, software may detect an increased footprint due to increased force applied to stylus 10 and display a wider or heavier line on touch screen 14.

Tip 50 may further include a support portion or core 68. Core 68 provides structural support to tip 50 by preventing excessive deformation of coupling portion 52 and reducing the likelihood that force applied to stylus 10 will be able to deform contact portion 54 but not deform coupling portion 52 to such an extent that tip 50 is decoupled from front barrel 30. Core 68 may include features such as arms or flanges to stabilize core 68 relative to front barrel 30.

When stylus 10 is assembled and grasped by a user similar to a pen or other writing implement, the user contacts front barrel 30, and or trim ring 40. The geometry of hollow end 36 of front barrel 30 provides sufficient contact area between front barrel 30 and tip 50 to conductively couple front barrel 30 to tip 50. Front barrel 30, trim ring 40, and tip 50 are all formed from conductive materials such that a conductive path is formed between the user and tip 50. When tip 50 contacts capacitive touch screen 14, a conductive path is therefore formed between the user and capacitive touch screen 14.

According to an exemplary embodiment, front barrel 30 is formed of a carbon fiber reinforced polymer. Carbon fiber is also referred to as CFRP (Carbon fiber-reinforced polymer) or CRP (carbon fiber-reinforced plastic). Carbon fiber is formed by weaving carbon fibers into a mat that can be shaped into a particular shape to define the component. The carbon fiber mat which can have different weave configurations such as twill weave for example is placed into a mold that represents the shape of the component to be manufactured. An epoxy resin is then introduced into the mold and heated or air-cured to form the carbon fiber component. Alternatively an epoxy resin can be preimpregnated into the fibers prior to being woven together.

In still another method, the carbon fiber mat may be draped over a mold and then an epoxy resin is painted over the mat to maintain the shape. It is believed that the direction of the weft and warp in the mat can be varied to maximize the strength characteristics of the component being manufactured. Similarly, it is believed that the orientation of the weave can also impact the conductivity of the carbon fiber components.

An approximation of the conductivity of a carbon fiber reinforced polymer can be determined with the equation:

$${σ}_{L} = \frac{C ( L + \frac{N}{2} )}{{N}_{T}} \qquad ( 1 )$$

where σ_{L} s the electrical conductivity of the material along the desired direction in mhos/m, C is the electrical conductivity of a unidirectional laminate, L is the number of layers in the desired direction (e.g., generally along longitudinal axis 12 for stylus 10), N is the number of layers with fibers oriented at a 45 degree angle to the desired direction, and N_{T} is the total number of layers. The front barrel 30 is constructed such that a sufficient percentage of the reinforcing carbon fibers are oriented in the desired direction. In this way, front barrel 30 provides a conductive path between the user and tip 50.

Trim ring 40 is formed from a conductive material. According to an exemplary embodiment, trim ring 40 is a metal such as aluminum or another conductive material. The material for trim ring 40 may be chosen to provide a visual contrast to front barrel 30 and/or rear barrel 20.

Tip 50 is formed of a resilient, conductive material. In one embodiment, tip 50 may be a metal-impregnated silicone material. In other embodiments, tip 50 may be formed of a conductive fabric. In still other embodiments, tip 50 may include a conductive substrate covered by a non-conductive layer. In such embodiments, the non-conductive layer may be chosen to enhance improve the ability of stylus 10 to slide across touch screen 14 or reduce smudging on touch screen 14. The non-conductive layer is thin enough to allow a tip 50 to be conductively coupled to touch screen 14.

As shown in FIGS. 1-5, rear barrel 20 may be formed of a non-conductive material such as a polymer. According to one exemplary embodiment, rear barrel 20 is formed of acrylonitrile butadiene styrene (ABS). In other embodiments, rear barrel 20 may alternatively be formed of another material such as another polymer, a metal, or a composite material such as a carbon fiber composite similar to front barrel 30.

A human user provides a sufficient charge that permits the capacitive touch screen to recognize where on the screen the human finger is touching. A stylus may be used as an extension of the human hand and\or fingers to be identified by the capacitive touch screen. For the stylus to act as an extension the stylus must provide an electrical path from the user's hand or fingers to capacitive screen. As discussed herein the fiver carbon barrel front barrel has sufficient conductive properties to provide the electrical path between the user and conductive tip 14 to allow a capacitive touch screen to identify the stylus. As a result of the conductive properties of fiber carbon no additional charge is required for the capacitive screen to identify the location of the stylus tip. However in an exemplary embodiment stylus 10 does not include any internal electrical charge component such as a battery to provide an electrical charge. In an alternative embodiment, an electrical charge mechanism maybe housed within the stylus to augment the electrical charge of the stylus.

In one embodiment, front barrel 30 is formed of a fiber carbon weave that has a weft and warp. The weft and warp are arranged such that both the weft and warp extends from a first end of front barrel 30 proximate tip 50 to the second end of front barrel 30 distal tip 50 and proximate trim ring 50. In one embodiment the weave is a twill weave with both the weft and warp wrapping around the front barrel around a longitudinal axis of the stylus 10. In this manner a continuous strand of the weft and warp provide a conductive path from both ends of front barrel 30. Other weave patterns are also contemplated as well as other weft and warp orientations that provide sufficient conductive path between a user and tip 50. In other embodiments the rear barrel 20 is also formed of a carbon fiber weave with a weft and warp that provide a conductive path from both ends of rear barrel 20 in the same manner as the weave in front barrel 30.

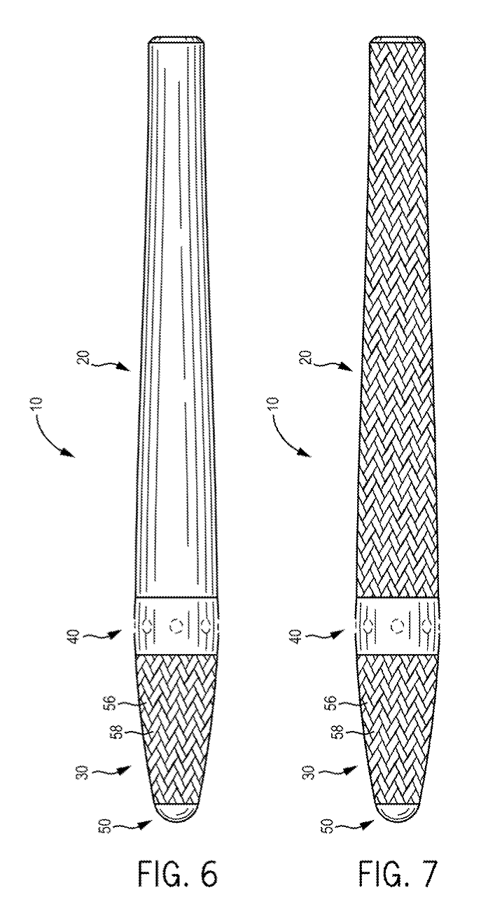

Referring now to FIG. 6, a case 60 (e.g., package, container, etc.) for stylus 10 is shown according to an exemplary embodiment. Case 60 is formed of a transparent material that allows stylus 10 to be displayed in a retail setting. After purchase, case 60 may be used as a travel case to store and transport stylus. Case 60 includes a recess 62 (e.g., socket, opening, hollow, etc.) that is shaped to receive the tip 50 and a portion of front barrel 30. Case 60 may be used as a stand for stylus 10 by inserting stylus 10 into recess 62. Recess 62 has a depth that is sufficient to maintain stylus 10 in an upright position.

The present disclosure has been described with reference to exemplary embodiments, however, workers skilled in the art will recognize that changes may be made in form and detail without departing from the spirit and scope of the disclosure. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example is manifestly intended to be as broad as possible. For example, unless specifically otherwise noted a single particular element may also encompass a plurality of such particular elements.

It is also important to note that the construction and arrangement of the elements of the system as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the exemplary embodiments without departing from the spirit of the present subject matter.

What is claimed is:

1. A stylus, comprising:
an elongated body a portion of which is formed from carbon fiber;
a tip conductively coupled to the elongated body.

2. The apparatus of claim 1, wherein the elongated body includes a front barrel formed from carbon fiber connected to the tip.

3. The apparatus of claim 2, further including an annular conductive ring conductively coupled to the front barrel forming a conductive path to the tip.

4. The apparatus of claim 3, wherein the elongated body includes a rear barrel operatively connected to the conductive ring distal the front barrel.

5. The apparatus of claim 4, wherein the rear barrel is formed from a non-conductive material.

6. The apparatus of claim 3, wherein the rear barrel is formed from carbon fiber.

7. The apparatus of claim 5, wherein the front barrel is hollow.

8. The apparatus of claim 7, wherein the rear barrel is hollow.

9. The apparatus of claim 5, wherein the carbon fiber is a orientated to provide sufficient conductive properties to provide a conductive path between the tip and the hand of a user.

10. The apparatus of claim 9, wherein the tip is formed from a conductive plastic material.

11. The apparatus of claim 10, wherein the tip has a contact portion configured to contact a screen of an electronic capacitive device and a distal portion coupled to the first barrel.

12. The apparatus of claim 11, wherein the contact portion may be deformed with the application of pressure to provide an increased footprint of the contact portion against the capacitive screen.

13. The apparatus of claim 1, wherein the carbon fiber is in the form of a weave having a weft and warp, with the at least one of the weft and warp extending continuously from a first end of the front barrel to the second end of the front barrel proximate the tip.

14. The apparatus of claim 6, wherein the carbon fiber is in the form of a weave having a weft and warp with the weft and warp extending continuously from along an entire length of each of the front barrel and rear barrel.

15. A conductive stylus for use with a capacitive sensing screen; the stylus comprising:
an elongated body including a portion formed from a conductive carbon fiber weave;
a conductive tip conductively coupled to the elongated body;
wherein the portion formed from a conductive carbon fiber weave extends from a first end of the elongated proximate the tip in a direction towards a second end distal from the tip.

16. The stylus of claim 15, wherein the carbon fiber weave includes a weft and a warp, the weft and warp extending continuously from the first end of the elongated body toward the second end a sufficient distance to be grasped by a user's fingers.

17. The stylus of claim 16, wherein weft and a warp wrap around the elongated body.

18. The stylus of claim 17, wherein the first portion is a front barrel operatively conductively connected to the tip.

19. The stylus of claim 18, further including a rear barrel formed from a conductive carbon fiber weave and in conductive connection with the front barrel.

20. The stylus of claim 19, wherein the carbon fiber weave includes a web and a warp, the weft and warp extending continuously from the first end of the elongated body toward the second end a sufficient distance to be grasped by a user's fingers.
